(19) United States
(12) Patent Application Publication
(10) Pub. No.: US 2025/0347493 A1
(43) Pub. Date: Nov. 13, 2025

(54) SLING PAD SYSTEM

(71) Applicant: Northrop Grumman Systems Corporation, Falls Church, VA (US)

(72) Inventor: Michael S. Huber, Fairfield, CA (US)

(21) Appl. No.: 18/657,834

(22) Filed: May 8, 2024

(51) Int. Cl. F41F 3/052; B29C 45/17; B29C 45/26; B29L 31/00

(52) U.S. Cl. CPC F41F 3/052; B29C 45/1742; B29C 45/2616; B29C 2045/1784; B29L 2031/777

(57) ABSTRACT

A sling pad system to be disposed between a missile and a launch tube is provided herein. The sling pad system includes an outer sheet and an inner sheet spaced from the outer sheet. A resilient structure is positioned between the outer sheet and the inner sheet. The resilient structure includes one or more structural elements operably coupled with the outer sheet at a first contact point and the inner sheet at a second contact point. A support is operably coupled with the inner sheet.

### FIELD

The present disclosure relates generally to a sling pad system, which may be in the form of a launch pad and/or a stowage pad, and more particularly to launch pads and stowage pads that may be utilized within missile launching systems to maintain missile alignment.

### BACKGROUND

Launch pads and stowage pads may be used in missile launching systems to maintain missile alignment, mitigate shock and vibration, and/or provide lateral support to the missile during launch. In some instances, a plurality of pad units containing chevron-shaped struts may be used to perform these functions. Due to the segmented nature of the pad units and the curved annular space, however, a desirable plateau characteristic is considerably diminished when the overall pad row (ring level) force/deflection characteristics are developed. Accordingly, an improved system and method would be welcomed in the technology.

### BRIEF DESCRIPTION

Aspects and advantages of the present disclosure will be set forth in part in the following description, or may be obvious from the description, or may be learned through practice of the present disclosure.

According to some aspects of the present disclosure, a sling pad system is to be disposed between a missile and a launch tube. The sling pad system includes an outer sheet and an inner sheet spaced from the outer sheet. A resilient structure is positioned between the outer sheet and the inner sheet. The resilient structure includes one or more structural elements operably coupled with the outer sheet at a first contact point and the inner sheet at a second contact point.

According to some aspects of the present disclosure, a method of manufacturing a payload assembly is provided herein. The method includes placing an injector mold plate of a mold assembly in a defined position relative to an ejector mold plate to define a casting mold. The method further includes moving one or more corebars within the mold assembly along a common translational axis. Lastly, the method includes injecting a material between the injector mold plate and the ejector mold plate to form an outer sheet, an inner sheet, and a resilient structure positioned between the outer sheet and the inner sheet.

According to some aspects of the present disclosure, a sling pad system is to be disposed between a missile and a launch tube. The sling pad system includes an outer sheet and an inner sheet spaced from the outer sheet. A resilient structure is positioned between the outer sheet and the inner sheet. The resilient structure includes a first structural element and a second structural element that intersect one another between the outer sheet and the inner sheet. A support is operably coupled with the inner sheet.

These and other features, aspects, and advantages of the present disclosure will be further supported and described with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a top plan view of a payload assembly that includes a payload, a surrounding housing separated from the payload, and a sling pad system in accordance with various aspects of the present disclosure;

FIG. 2 illustrates a perspective view of the sling pad system in accordance with various aspects of the present disclosure;

FIGS. 3A-3D illustrate respective top views of examples of the payload assembly in accordance with various aspects of the present disclosure;

FIG. 4A illustrates a top plan view of the sling pad system in accordance with various aspects of the present disclosure;

FIG. 4B illustrated an enhanced view of section IVB of FIG. 4A in accordance with various aspects of the present disclosure;

FIGS. 5-7 illustrates a top view of the payload assembly experiencing various displacements in accordance with various aspects of the present disclosure;

FIGS. 8-10 illustrates a top view of the payload assembly experiencing various displacements in accordance with various aspects of the present disclosure;

FIGS. 11-13 illustrates a top view of the payload assembly experiencing various displacements in accordance with various aspects of the present disclosure;

FIGS. 14-16 illustrates a top view of the payload assembly experiencing various displacements in accordance with various aspects of the present disclosure;

FIGS. 17A and 17B illustrate the sling pad system having a sealing region in accordance with various aspects of the present disclosure;

FIG. 18 illustrates a flow diagram for manufacturing a payload assembly in accordance with various aspects of the present disclosure; and

FIG. 19 illustrates a flow diagram for manufacturing a payload assembly in accordance with various aspects of the present disclosure.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The terms “coupled,” “fixed,” “attached to,” and the like refer to both direct coupling, fixing, or attaching, as well as indirect coupling, fixing, or attaching through one or more intermediate components or features, unless otherwise specified herein. Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the disclosed functionality, and any two components capable of being so associated can also be viewed as being “operably couplable” to each other to achieve the disclosed functionality. Some examples of operably couplable include, but are not limited to, physically mateable, physically interacting components, wirelessly interactable, wirelessly interacting components, logically interacting, and/or logically interactable components.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a sling pad system that may be disposed between a payload (e.g., a missile) and a surrounding housing (e.g., a launch tube).

In some examples, the sling pad system can include an outer sheet and an inner sheet spaced from the outer sheet. A resilient structure can be positioned between the outer sheet and the inner sheet. The resilient structure can include one or more structural elements operably coupled with the outer sheet at a first contact point and the inner sheet at a second contact point. A support can be operably coupled with the inner sheet. In some cases, the support can be configured as a preformed material formed from at least one of a metallic material, an elastomeric material, a polymeric material, or a synthetic material. Additionally or alternatively, the support can be configured as a thicker region along the inner sheet compared to the one or more structural elements.

The sling pad system provided herein can create a more even distribution of a restoring force to the skin of the payload when the payload is displaced from a default position, the surrounding housing, and/or the sling pad system. As such, the sling pad system provided herein can have thinner components so that the collapse height is smaller, which, in turn, allows the sling pad systems to develop greater stroke, which enables absorbing more energy at a given plateau pressure. Moreover, the sling pad system provided herein can increase performance and reduce the cost of shock/stowage/launch sling pad systems (also known as lateral support pads). Further, an architecture of the sling pad system provided herein can increase a range of viable solutions to meet new and more challenging requirements such as increased shock mitigation, lower contact forces (local forces imposed on the payload skin by the pad architecture), and greater crossflow capability during launch. The sling pad system provided herein can also lower peak strains in the sling pad system material over the effective stroke, which may be desirable for increasing the performance and resilience of the sling pad systems. For instance, typical hyper-elastic materials may perform more consistently when peak strain is limited to approximately 20-25% as this keeps the strain largely out of the non-linear portion of a typical hyper-elastic material's stress/strain curves. In some cases, this sort of design goal may be easier to achieve with the tension webs of a sling pad architecture than with the hinges and bending knees of a legacy buckled strut architecture.

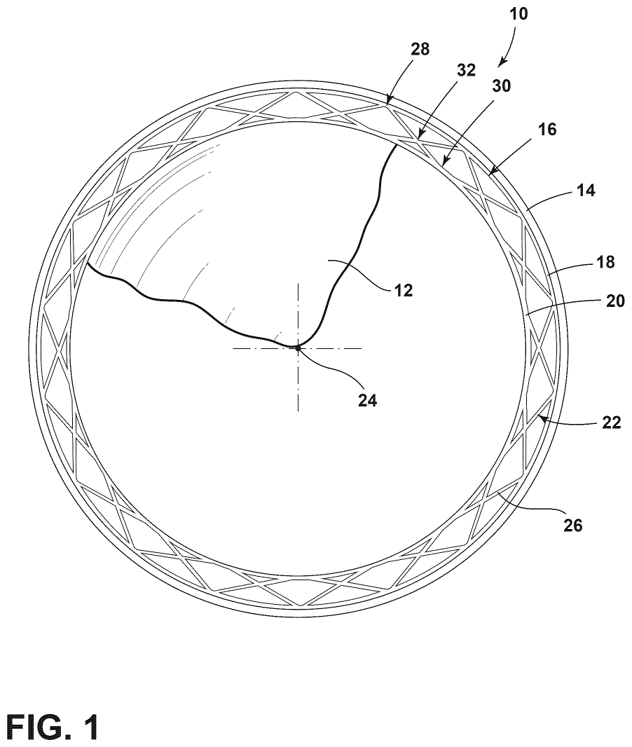

Referring now FIG. 1, a payload assembly 10 can include a payload 12, a surrounding housing 14 separated from the payload 12 and configured to support the payload 12, and a sling pad system 16 positioned between the payload 12 and the surrounding housing 14. For instance, the payload 12 may be in the form of a missile, and the surrounding housing 14 may be in the form of a launch tube with the sling pad system 16 positioned between the launch tube and the missile. However, it will be appreciated that the sling pad system 16 provided herein may be used in any other manner without departing from the scope of the present disclosure.

As illustrated in FIG. 1, the sling pad system 16 can include an outer sheet 18 and an inner sheet 20, which may be a cylinder, a truncated cylinder, or any other geometry. In some examples, the outer sheet 18 can define an outer perimeter portion of the sling pad system 16. In some cases, the outer region of the outer sheet 18 may be adhered to or otherwise coupled with surrounding housing 14, such as a launch tube. The inner sheet 20 can define an inner perimeter portion of the sling pad system 16. In various cases, the inner sheet 20 may contact the payload 12. In some cases, the inner sheet 20 may be compressively retained, adhered to, or otherwise contact the payload 12. The outer sheet 18, the inner sheet 20, and/or the resilient structure 22 may be elastically deformable to maintain alignment of the missile within the launch tube, mitigate shock and vibration, and/or provide lateral support to the missile during launch and/or at any other time.

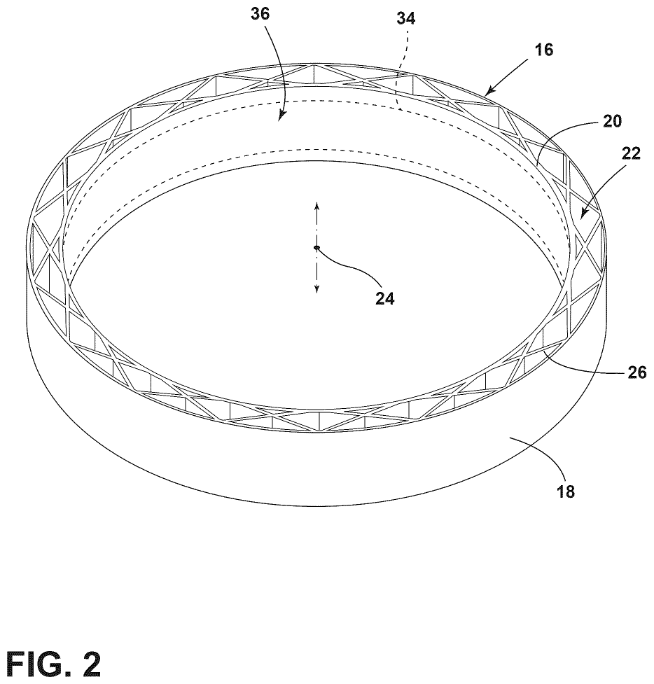

In examples in which the outer sheet 18 and the inner sheet 20 are cylindrical, the outer sheet 18 and the inner sheet 20 may be coaxial with one another about a common axis 24. In such instances, the inner sheet 20 may be separated from the outer sheet 18 to define a thickness of the resilient structure 22 therebetween. In some examples, such as the ones illustrated in FIGS. 1 and 2, the resilient structure 22 can include one or more structural elements 26. In various examples, the structural elements 26 may be integrally formed with and/or otherwise coupled with one or more of at least one additional structural element 26, the outer sheet 18, and/or the inner sheet 20. The resilient structure 22 may be configured to create a sling pad system 16 that utilizes a structural element length that can minimize and/or reduce peak strain for a defined stiffness and stroke. For instance, one or more of the structural elements 26 may be configured to be integrally formed and/or otherwise operably coupled with the outer sheet 18 at a first contact point 28 and the inner sheet 20 at a second contact point 30. In some cases, the first contact point 28 may be circumferentially (or tangentially) offset from one another about the common axis 24 of the outer sheet 18 and the inner sheet 20. In addition, the structural element 26 may intersect one or more other structural elements 26 at an intersection point 32 that may be between the first contact point 28 and the second contact point 30.

With further reference to FIG. 2, in various examples, the sling pad system 16 may include a support 34. For example, the support 34 may be operably coupled with the outer sheet 18, the inner sheet 20, and/or the resilient structure 22 of the sling pad system 16. In some examples, the support 34 may be configured as an inner hoop that is operably coupled with the inner sheet 20. In some cases, the support 34 may be operably coupled (directly or indirectly) with the outer sheet 18, the inner sheet 20, and the resilient structure 22 that, in combination, work largely in tension. As such, the sling pad system 16 provided herein can increase a sling pad system footprint on the payload 12 and engage more of the sling pad system material to resist deflection and generate net restoring force. These attributes can lower peak contact forces on the payload 12 and decrease peak and average strains in the sling pad system 16. It will be appreciated that the support size, material, and modulus can be altered to fine-tune the sling pad system force-deflection curves. The ability to add various supports with the tension resilient structure 22, along with the ability to form various parts of the sling pad system 16 can increase the range of viable sling pad system materials (resulting from lower peak strains and simplified mold architecture), which, in turn, can expand the viable design space compared to legacy compression sling pad systems.

In some instances, the support 34 may have a higher tensile modulus (or a lower tensile modulus) than the inner sheet 20, which may be accomplished by forming a thicker region along the inner sheet 20 compared to the one or more structural elements 26 and/or operably coupling an additional component (any structure that is continuous or non-continuous and formed from a material that is varied from the material forming the inner sheet 20) to the inner sheet 20. In instances in which the support 34 is an additional component, the support 34 may be insert-molded with the outer sheet 18, the inner sheet 20, and/or the resilient structure 22. Additionally or alternatively, the support 34 may be later attached or otherwise coupled with the outer sheet 18, the inner sheet 20, and/or the resilient structure 22.

In various examples, such as the example of FIG. 2, the inner sheet 20 and/or the support 34 can bear against the payload 12. As such, the inner sheet 20 and/or the support 34 can include a layer 36 thereon that is configured to reduce an amount of friction between the payload 12 and the inner sheet 20 and/or the support 34. For instance, the layer 36 may include a polytetrafluoroethylene material, and/or any other material. In some instances, the layer 36 may be configured to exhibit nonstick, waterproof, noncorrosive, and/or nonreactive characteristics. In some cases, the sling pad system 16 may experience quality checks and/or other testing before end usage within the payload assembly 10. Due to the deformation characteristics exhibited by the sling pad system 16 provided herein, the layer 36 may have less degradation during quality assurance (QA) testing and operation when compared to legacy sling pad systems that include a layer 36 thereon.

In several examples, the sling pad system 16, or portions thereof, can be formed from an energy-absorbing material that behaves in a rate-independent hyperelastic manner wherein its permanent set is minimized so that the energy-absorbing material maintains consistent force-displacement characteristics over a wide range of forces while remaining substantially fully recoverable. Hyperelastic materials have the ability to do work by absorbing kinetic energy transferred from impact through an clastic deformation with little viscous damping, heat dissipation (from friction forces), or permanent deformation (i.e., permanent set). This mechanical energy can then be returned to nearly its original shape (e.g., about 100%) allowing the components to return to their original configuration before impact with negligible strain. In various examples, an overall pad resilience may be improved due to the peak strains under maximum pad displacement in the resilient structure of the sling pad system 16 provided herein may be lower than the peak strains in a legacy buckled strut sling pad.

Further, the hyperelastic material can behave in a hyperelastic manner under dynamic loadings of high strain rates of up to at least 900-1000 s⁻¹. The hyperelastic material can allow for movement of the payload 12 relative to the surrounding housing 14 and also allow for the recovery of the sling pad system 16 to its original geometry, or a generally similar geometry in which the deformation is maintained below a defined threshold (e.g., 10%). The hyperelastic material can have non-linear elastic responses when deformed from its original geometry. It will be appreciated that the hyperelastic material may be in the form of a thermosetting urethane or any other practicable material that can exhibit elastic, superelastic, or hyperstatic characteristics.

In various examples, the sling pad system 16 provided herein may generate a generally uniform loading on the payload 12. However, in some cases, the sling pad system 16 may create more of a rising rate force/deflection curve rather than a ramp-plateau characteristic. In some instances, this characteristic may be improved by creating a sling pad system 16 that can be pre-loaded during installation. In such instances, the sling pad system 16 may be cast/fabricated in two parts. For instance, a first part may include the outer sheet 18 while the second part includes the remaining components of the sling pad system 16, which can include the inner sheet 20 and/or one or more web elements 26. Moreover, in several examples, the second part may be cast, molded, and/or additively manufactured such that the web elements 26 may have a non-stretched length that is less than a default distance between the outer sheet 18 and the inner sheet 20. In such instances, the web elements 26 may be stretched from their default length to attach (by any number of methods) to the outer sheet 18 so that tension is generated in the web elements 26 upon installation. Accordingly, the web elements 26 may be pre-stretched so that the web elements 26 may act to create a quicker ramp up of the force/deflection curve of the sling pad system 16 when displaced and create a plateau by transitioning into the hyper-elastic material zone as displacement increases.

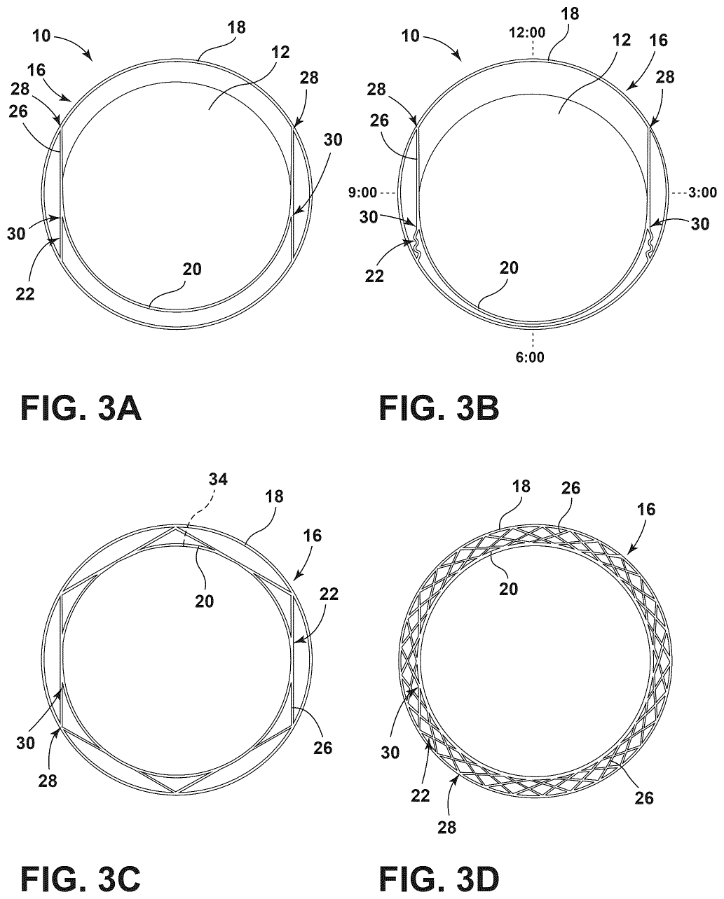

Referring now to FIGS. 3A-3D, in some examples, the sling pad system 16 may include varying amounts of web elements 26 within the resilient structure 22. For instance, as the number of web elements 26 increases, e.g., from the amount shown in FIGS. 3A and 3B to the amounts shown in FIGS. 3C or 3D, the pure sling loading on the inner sheet 20 may be reduced. With further reference to FIGS. 3A and 3B, as illustrated, the sling pad system 16 may include two web elements 26 that may be parallel to one another and tangent to the inner sheet 20, for example on opposing lateral sides of the inner sheet 20. In such instances, when the payload 12 and the sling pad system 16 are displaced in a direction that is generally downward and parallel to the two web elements 26, the inner sheet 20 may act on one hundred and eighty degrees of the payload (based on uniform payload skin loading in the lower half of the payload in FIG. 3B). Additionally, a first portion (e.g., a top portion in FIG. 3B) of the web elements 26 may experience tension and/or stretching while a second portion (e.g., a bottom portion in FIG. 3B) of the web elements 26 may experience compression. In some examples, the buckling or compression of the second portion may exhibit little contribution to loading. The portions of the web elements 26 that experience tension and/or compression may be altered based on the displacement direction and magnitude. Moreover, portions of the inner sheet 20 may also experience tension/stretching. In some cases, when the support 34 is operably coupled with the inner sheet 20, (which may have a higher modulus material) the tension/stretching may be primarily within the web elements 26.

With further reference to FIGS. 3C and 3D, additional web elements 26 may be added to the resilient structure 22. For instance, as shown in FIG. 3C, the resilient structure 22 may include six web elements 26 and a support 34, which may have a modulus that is greater than that of the inner sheet 20 and/or the web elements 26. In such instances, the sling pad system 16 may act to restore the payload 23 (FIG. 1) if the payload 12 is displaced in any direction. In various examples, the six web elements 26 may be primarily in tension with some being of the web element 26. Moreover, with a resilient structure 22 that incorporates six web elements 26, the sling pad system 16 may experience some directional variation in a force/deflection curve.

As shown in FIG. 3D, the resilient structure 22 may include more web elements 26 than (e.g., any number of web elements 26) shown in FIGS. 3A-3C. However, it will be appreciated that the resilient structure 22 may include any number (e.g., one to any practicable number) of web elements 26 without departing from the scope of the present disclosure. In the example illustrated in FIG. 3D, the resilient structure 22 may include twenty-nine web elements 26, and may or may not include a support 34 (FIG. 3C). In such cases, the primary restoring force may still be generated by tension & shear in the web elements 26 and the inner sheet 20. As provided wherein, the support 34 may be operably coupled with the inner sheet 20. In the example shown in FIG. 3D, the multiple intersection points 32 of the web elements 26 may stiffen the sling pad system 16, but may diminish some uniformity of a sling load, as the resulting cellular structure has a moderate compressive strength.

In some cases, with additional web elements 26, two web elements 26 may still be attached at the further laterally outward points of the inner sheet 20 (e.g., 3:00 and 9:00 positions if the inner sheet is view as a clock with 12:00, 3:00, 6:00, and 12:00 each being one quarter of a circle apart from one another and 12:00 oriented at a top portion of the pad system 16, as illustrated in FIG. 3B). Alternatively, in some instances, the contact point 30 may be positioned slightly inboard or outboard of a tangent connection, as altering the inboard connection point 30 changes the “pattern” of the web elements 26 as the number of web elements 26 in the pattern is increased. In some examples, the connection points 30 slightly inboard (which effectively means that the two contact points 30 shift to four contact points), such that the connection points 30 may be positioned at about 2:30, 3:30, 8:30, and 9:30, rather than the former 3:00 and 9:00 connections. As such, shifting the contact points 30 inboard or outboard of the laterally outward points may have an effect on the performance of the resilient structure 22.

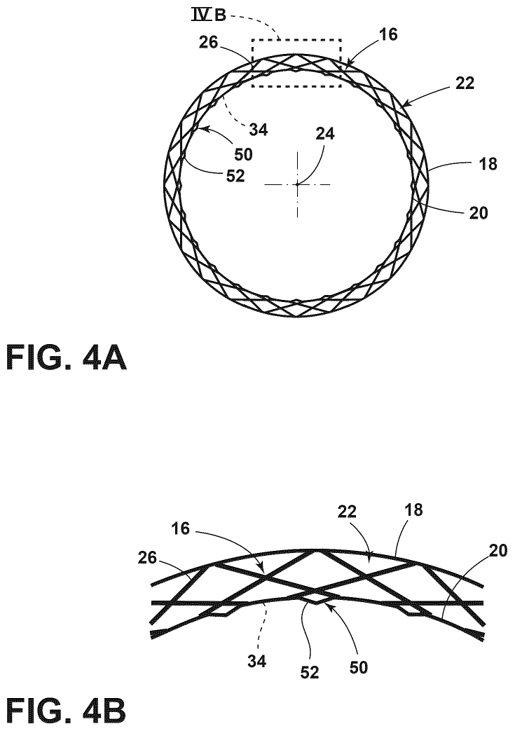

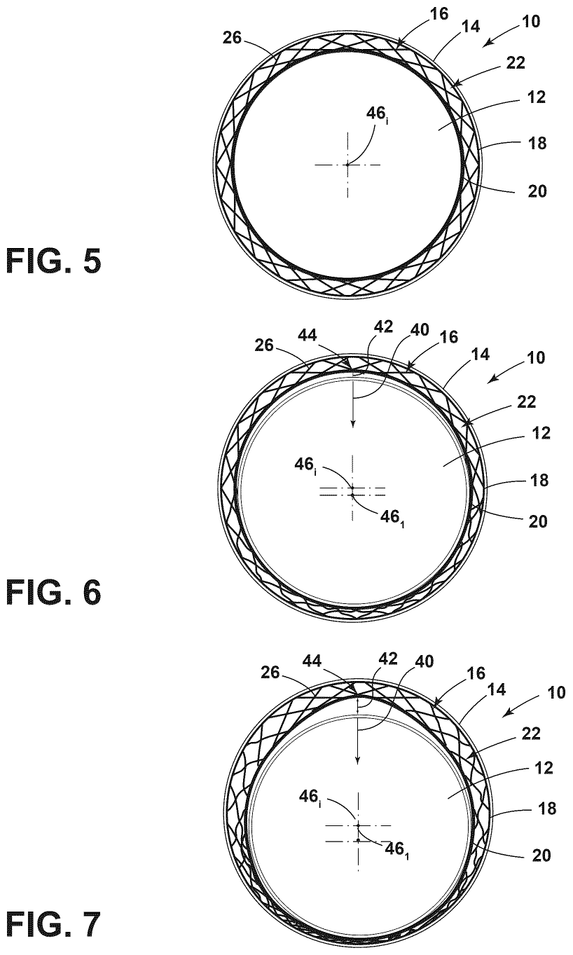

Referring now to FIGS. 4A and 4B, in some cases, the sling pad system 16 may include a tolerance region 50 that may be operably coupled with and/or integrally formed with the outer sheet 18, the inner sheet 20, and/or any other component of the sling pad system 16. At times, a certain amount of tolerance build-up between the payload 12 and the sling pad system 16 and/or the sling pad system 16 and the surrounding housing 14 may tend to loosen a mating relationship between the various components of the payload assembly 10. The tolerance region 50 may compensate for this extra tolerance and/or increase the gripping force of the sling pad system 16 to the payload 12 and/or the surrounding housing 14. As shown, the tolerance region 50 can include extensions 52 that can extend inwardly (towards the common axis 24) from the inner sheet 20. Additionally or alternatively, the tolerance region 50 can include extensions 52 that can extend outwardly (away from the common axis 24) from the outer sheet 18. In various examples, the tolerance region 50 may be configured to not add extra thickness to the fully-compressed stack-up of the pad system 16. In such examples, the tolerance region 50 may be configured as “ripples” or “corrugations” in the inner sheet 20 rather than features that combine to add thickness to the inner sheet 20 and thus to the fully compressed stack height. It will be appreciated that, in some instances, the tolerance region 50 may also generally allow the support 34 to be slightly larger than the diameter of the payload 12. Such a configuration may avoid high encapsulation forces or friction loads while still allowing the pad system 16 to act in a sling-like manner. Additionally or alternatively, the tolerance region 50 may be configured as “ripples” or “corrugations” in the outer sheet 18 rather than features that combine to add thickness to the outer sheet 18.

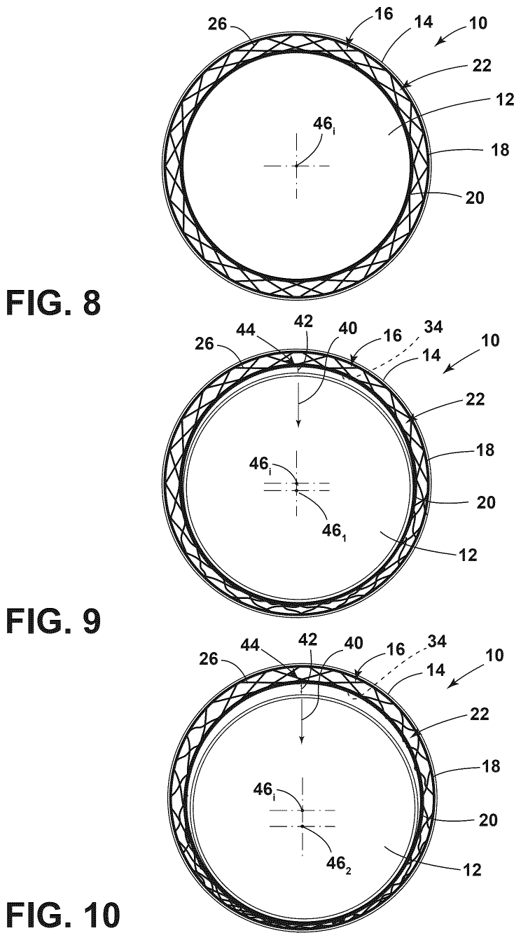

Referring now to FIGS. 5-7, a displacement (illustrated by arrow 40 in FIGS. 6 and 7) of the payload 12 and the sling pad system 16 within the surrounding housing 14 is shown. Specifically, Specifically, FIG. 5 illustrates the payload 12 and the sling pad system 16 within the surrounding housing 14 before the payload 12 experiences the displacement with the initial axis of the payload labeled as 46ᵢ. FIG. 6 illustrates the payload 12 and the sling pad system 16 within the surrounding housing 14 with a displacement of the payload 12 at a first displacement with the initial axis of the payload labeled as 46ᵢ and the payload axis at the first displacement labeled as 46₁. and FIG. 7 illustrates the payload 12 and the sling pad system 16 within the surrounding housing 14 with the displacement of the payload 12 at a second displacement that is greater than the first displacement with the initial axis of the payload labeled as 46ᵢ and the payload axis at the second displacement labeled as 46₂. The arrow 40 indicate the direction of the displacement of the payload 12.

In the examples illustrated in FIGS. 5-7, the outer sheet 18 may be at least partially adhered to or otherwise coupled with a surrounding housing 14. As the payload 12 is displaced, the components of the sling pad system 16 may deform causing a separation distance 42 is defined between the payload 12 and a separation region 44 of the sling pad system 16 as one or more components of the sling pad system 16 are deformed. In general, the separation region can be controlled by the modulus of the support 34 and the relative stiffness of the support 34 that may be embedded and/or attached to the inner sheet 20 compared to the cumulative tension/shear forces being generated by the web elements 26. For example, a first segment of the resilient structure is extended, and a second segment of the resilient structure is compressed when the payload 12 is displaced. In response to the deformation of the sling pad system 16, the sling pad system 16 can provide a collection of restoring structural elements 26 in the form of the resilient structure 22 positioned between the outer sheet 18 and the inner sheet 20 that can work in tension to resist deflection of the payload 12 and generate a net restoring force. In some cases, these attributes can dramatically lower peak contact forces on the payload 12 and decrease peak and average strains in the sling pad system 16. As provided herein, the amount of restorative force generated by the sling pad system 16 can differ based on the materials used to form the sling pad system 16, the resilient structure 22, the thickness of the outer sheet 18, and the thickness of the inner sheet 20, the modulus of support 34 (if present), among other factors.

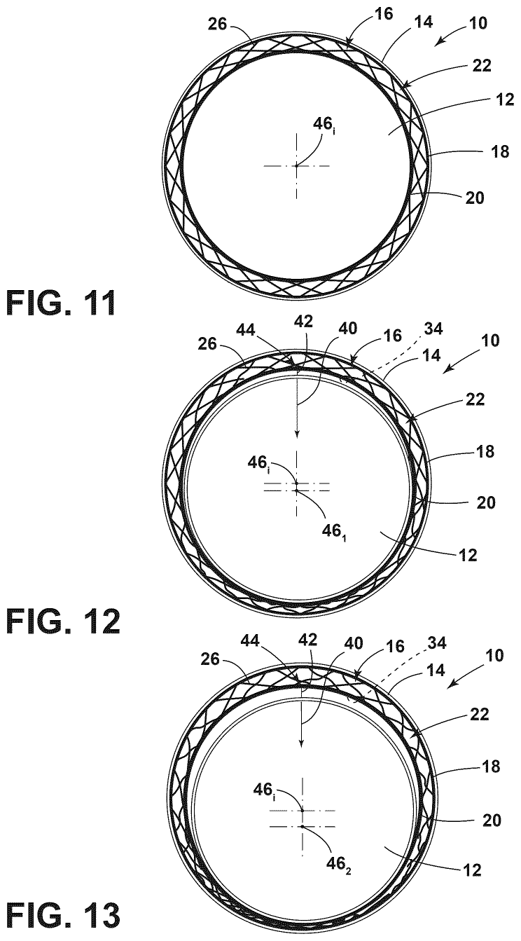

Referring now to FIGS. 8-10, a displacement (illustrated by arrow 40 in FIGS. 9 and 10) of the payload 12 and the sling pad system 16 within the surrounding housing 14 is shown. Specifically, Specifically, FIG. 8 illustrates the payload 12 and the sling pad system 16 within the surrounding housing 14 before the initiation of the displacement with the initial axis of the payload labeled as 46ᵢ. FIG. 9 illustrates the payload 12 and the sling pad system 16 within the surrounding housing 14 with the displacement at a first displacement with the initial axis of the payload labeled as 46ᵢ and the payload axis at the first displacement labeled as 46₁. and FIG. 10 illustrates the payload 12 and the sling pad system 16 within the surrounding housing 14 with the displacement at a second displacement that is greater than the first displacement with the initial axis of the payload labeled as 46ᵢ and the payload axis at the second displacement labeled as 46₂. The arrow 40 indicate the direction of the displacement of the payload 12.

In the example shown in FIGS. 8-10, the outer sheet 18 may be at least partially adhered to or otherwise coupled with a surrounding housing 14. In addition, the sling pad system 16 can include a support 34 along at least a portion of the inner sheet 20 in the form of a region including a polyoxymethylene (POM) material, which is a thermoplastic that exhibits a high stiffness, low friction, and/or a dimensional stability relative to various other thermoplastic materials. However, it will be appreciated that the support 34 can additionally or alternatively range from a hyper-elastic material (which may form one or more portions of the sling pad system 16) for a small, soft sling pad system 16, up to high modulus fibers, such as an aramid fiber, for a larger, stiffer sling pad system 16, and/or any other practicable material.

In the examples shown in FIGS. 8-10, as the payload 12 is displaced, the components of the sling pad system 16 may deform causing a separation distance 42 that is defined between the payload 12 and a separation region 44 of the sling pad system 16 as one or more components of the sling pad system 16 are deformed. For example, a first segment of the resilient structure is extended, and a second segment of the resilient structure is compressed when the payload is displaced. In the illustrated example, a first zone may generally be defined between 10:00 and 2:00 in which the resilient structure 22 may be generally in shear and tension. In some instances the first zone may generate a majority of the restoring force being transmitted to the compression side largely through the inner sheet 20 and the support 34. Additionally, a second zone may be in compression. The forces generated by buckling and compressing the elastic web elements 26 generated in the second zone (i.e., compression side) may generally be lower than the tension and shear forces being transmitted from the first zone, as otherwise some of the benefits of a sling pad architecture may be defeated by the first zone.

In some cases, the deformation may cause various components to deform from its non-displaced geometry. For instance, as the separation distance increases the shear and tension portions of the resilient structure 22 may resist deformation, and thus, deform the inner sheet 20 (with or without the support 34) into a slight egg-shape that creates the tension in the 3:00-to-9:00 region that defines a sling pad.

As shown, the separation distance 42 illustrated in FIGS. 8-10 may be less than the separation distance 42 of the example illustrated in FIGS. 5-7. In addition, the support 34 can transfer tension within the resilient structure 22 into a uniform sling load in a compression zone. In some instances, the higher-modulus support 34 may reduce the separation distance 42 by transferring the load along the circumference of the sling pad system 16 by involving more web elements 26 and by more stretching of the web elements 26 earlier in the displacement rather than allowing the stretch to occur in the inner sheet 20.

In response to the deformation of the sling pad system 16, the sling pad system 16 can provide a collection of restoring structural elements 26 in the form of the resilient structure 22 positioned between the outer sheet 18 and the inner sheet 20 that can work in tension to resist deflection of the payload 12 and generate a net restoring force. In some cases, these attributes can dramatically lower peak contact forces on the payload 12 and decrease peak and average strains in the sling pad system 16. As provided herein, the amount of restorative force generated by the sling pad system 16 can differ based on the materials used to form the sling pad system 16, the resilient structure 22, the thickness of the outer sheet 18, and the thickness of the inner sheet 20, among other factors.

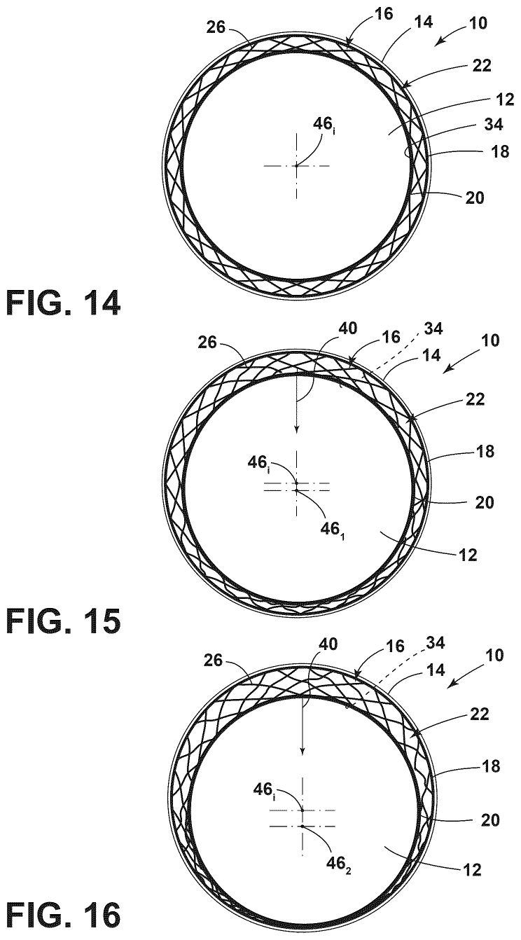

Referring now to FIGS. 11-13, a displacement (illustrated by arrow 40 in FIGS. 12 and 13) of the payload 12 and the sling pad system 16 within the surrounding housing 14 is shown. Specifically, Specifically, FIG. 11 illustrates the payload 12 and the sling pad system 16 within the surrounding housing 14 before the initiation of the displacement with the initial axis of the payload labeled as 46ᵢ. FIG. 12 illustrates the payload 12 and the sling pad system 16 within the surrounding housing 14 with the displacement at a first displacement with the initial axis of the payload labeled as 46ᵢ and the payload axis at the first displacement labeled as 46₁. and FIG. 13 illustrates the payload 12 and the sling pad system 16 within the surrounding housing 14 with the displacement at a second displacement that is greater than the first displacement with the initial axis of the payload labeled as 46ᵢ and the payload axis at the second displacement labeled as 46₂. The arrow 40 indicate the direction of the displacement of the payload 12.

In the example shown in FIGS. 11-13, the outer sheet 18 may be at least partially adhered to or otherwise coupled with a surrounding housing 14. In addition, the sling pad system 16 can include a support 34 along at least a portion of the inner sheet 20 in the form of a region including a preformed material that is insert molded and/or otherwise attached to the inner sheet 20 (and/or any other component of the sling pad system 16). In some cases, the preformed material may be a metallic material, an elastomeric material, a polymeric material, a synthetic material, and/or any other practicable material.

In the examples shown in FIGS. 11-13, as the payload 12 is displaced, the components of the sling pad system 16 may deform causing a separation distance 42 is defined between the payload 12 and a separation region 44 of the sling pad system 16 as one or more components of the sling pad system 16 are deformed. For example, a first segment of the resilient structure is extended, and a second segment of the resilient structure is compressed when the payload is displaced. As shown, the separation distance 42 illustrated in FIGS. 11-13 may be less than the separation distance 42 of the example illustrated in FIGS. 8-10. In addition, the support 34 can transfer tension within the resilient structure 22 into a uniform sling load in a compression zone. In some instances, the support 34 may reduce the separation distance 42 by distributing the load along the circumference of the sling pad system 16.

In response to the deformation of the sling pad system 16, the sling pad system 16 can provide a collection of restoring structural elements 26 in the form of the resilient structure 22 positioned between the outer sheet 18 and the inner sheet 20 that can work in tension to resist deflection of the payload 12 and generate a net restoring force. In some cases, these attributes can dramatically lower peak contact forces on the payload 12 and decrease peak and average strains in the sling pad system 16. As provided herein, the amount of restorative force generated by the sling pad system 16 can differ based on the materials used to form the sling pad system 16, the resilient structure 22, the thickness of the outer sheet 18, and the thickness of the inner sheet 20, among other factors.

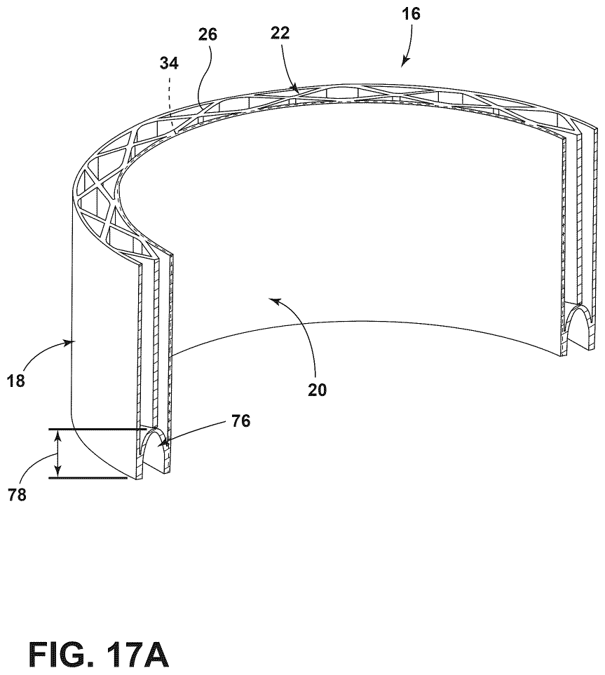

Referring now to FIGS. 14-16, a displacement (illustrated by arrow 40 in FIGS. 15 and 16) of the payload 12 and the sling pad system 16 within the surrounding housing 14 is shown. Specifically, Specifically, FIG. 14 illustrates the payload 12 and the sling pad system 16 within the surrounding housing 14 before the initiation of the displacement with the initial axis of the payload labeled as 46ᵢ. FIG. 15 illustrates the payload 12 and the sling pad system 16 within the surrounding housing 14 with the displacement at a first displacement with the initial axis of the payload labeled as 46i and the payload axis at the first displacement labeled as 46₁. and FIG. 16 illustrates the payload 12 and the sling pad system 16 within the surrounding housing 14 with the displacement at a second displacement that is greater than the first displacement with the initial axis of the payload labeled as 46ᵢ and the payload axis at the second displacement labeled as 46₂. The arrow 40 indicate the direction of the displacement of the payload 12.

In the example shown in FIGS. 14-16, the outer sheet 18 may be at least partially adhered to or otherwise coupled with a surrounding housing 14. It will be appreciated that the example shown in FIGS. 14-16 may be used as a radial bearing spring/damper, a suspension bushing, and/or for any other practicable purpose.

The sling pad system 16 can further include a support 34 along at least a portion of the inner sheet 20 in the form of a region including a preformed material that is insert molded and/or otherwise attached to the inner sheet 20 (and/or any other component of the sling pad system 16). In some cases, the preformed material may be a metallic material, an elastomeric material, a polymeric material, a synthetic material, and/or any other practicable material. In general, the preformed material can exhibit a high stiffness, low friction, and/or a dimensional stability relative to various other thermoplastic materials. Moreover, in the illustrated examples, the inner sheet 20 and/or the support 34 may be adhered to the payload 12. In such instances, the force may be further radially distributed about the payload 12.

As illustrated in FIGS. 14-16, as the payload 12 is displaced, the components of the sling pad system 16 may deform as one or more components of the sling pad system 16 are deformed. For example, a first segment of the resilient structure is extended, and a second segment of the resilient structure is compressed when the payload is displaced. In addition, the support 34 can transfer tension within the resilient structure 22 into a uniform sling load in a compression zone. In some instances, the support 34 may reduce the separation distance 42 by distributing the load along the circumference of the sling pad system 16. With regards to the example illustrated in FIGS. 14-16, a temporary or permanent attachment between the inner sheet 20 and the payload 12. For example, with a missile launching system, the configuration of FIGS. 14-16 may be used to launch the sling pad system 16 out of the surrounding housing 14 with the payload 12, then separate the sling pad system 16 from the payload 12. Additionally or alternatively, the configuration of FIGS. 14-16 may be used in situations in which the sling pad system 16 may be attached to the payload 12 but not to the surrounding housing 14. Additionally or alternatively, the configuration of FIGS. 14-16 may be used in conjunction with a radial bearing mount or a suspension bushing, an inner substrate attachment, and/or for any other purpose.

In response to the deformation of the sling pad system 16, the sling pad system 16 can provide a collection of restoring structural elements 26 in the form of the resilient structure 22 positioned between the outer sheet 18 and the inner sheet 20 that can work in tension to resist deflection of the payload 12 and generate a net restoring force. In some cases, these attributes can dramatically lower peak contact forces on the payload 12 and decrease peak and average strains in the sling pad system 16. As provided herein, the amount of restorative force generated by the sling pad system 16 can differ based on the materials used to form the sling pad system 16, the resilient structure 22, the thickness of the outer sheet 18, and the thickness of the inner sheet 20, among other factors.

With reference to FIGS. 14-16, as illustrated, the separation distance 42 may be varied and/or not existent, based on the configuration of the sling pad system 16. In several cases, the configuration of the sling pad system 16 may be altered and/or chosen based on the constraints and usage of a defined payload assembly.

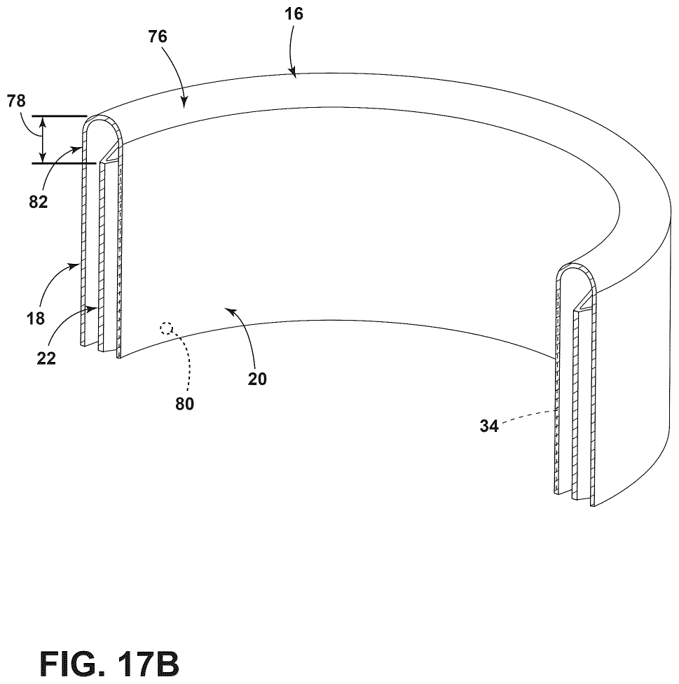

Referring now to FIGS. 17A and 17B, in some examples, the sling pad system 16 may further include a sealing region 76 that can control and/or effect eject gas flow during an eject event. In some examples, such as those illustrated in FIGS. 17A and 17B, the sealing region 76 may be positioned between the inner sheet 20 and the outer sheet 18 and may contact an axial end portion of the resilient structure 22. Additionally or alternatively, in some cases, such as the example illustrated in FIG. 17B, the sealing region 76 may be separated from the resilient structure 22 between the inner sheet 20 and the outer sheet 18.

As illustrated in FIG. 17A, the sealing region 76 may extend internally of the outer sheet 18, the inner sheet 20, and/or the resilient structure 22 in an axial direction to operably couple or seal the outer sheet 18 with the inner sheet 20. As shown, the sealing region 76 may define a sealing height 78 in the axial direction that defines a volume between the between the inner sheet 20 and the outer sheet 18, which may be separated from the resilient structure 22 by the sealing region 76. In the example illustrated in FIG. 17A, when present, eject gases may be separated from resilient structure 22. In such cases, the presence of the eject gas within the sealing volume may alter a force-deflection curve of the sling pad system 16. As such, the design of the resilient structure 22 may be determined based on a combination of the web elements, the changes in characteristics based on the presence of the eject gas within the sealing volume, the support 34, and/or other factors. In some instances, when the sealing region 76 is positioned in a lower section of the sling pad system 16, an axial compression load may be created on the inner sheet 20 of the sling pad system 16. Moreover, the sling pad system 16 may include an embedded support 34 to mitigate or prevent local buckling.

As illustrated in FIG. 17B, the sealing region 76 may extend externally from the outer sheet 18, the inner sheet 20, and/or the resilient structure 22 in an axial direction to operably couple or seal the outer sheet 18 with the inner sheet 20. As shown, the sealing region 76 may define a sealing height 78 in the axial direction that defines a volume between the resilient structure and the sealing region. In some instances, the scaling height may be determined by the maximum radial displacement expected on the “tension side” of the sling pad system 16. For instance, a length of the half-toroid and vertical legs 82 of the sealing region 76 shown in FIG. 17B, with the sling pad in a “centered” position, may be determined by sizing the legs 82 to attain a half-toroid seal geometry with diminished legs 82 and a larger half-toroid radius at a maximum annular gap. Conversely, on the “compression side,” the legs 82 may effectively become longer and the half-toroid radius smaller as the annular gap diminishes.

In the example illustrated in FIG. 17B, when present, eject gases may be disposed within the sling pad system, such as any open area between the inner sheet 20 and the outer sheet 18. As such, the eject gas may be present within the resilient structure 22. In such cases, the presence of the eject gas may alter a force-deflection curve of the sling pad system 16. As such, the design of the resilient structure 22 may be determined based on a combination of the web elements 26, the changes to the resilient structure 22 based on the presence of the eject gas, the support 34, and/or other factors. In various examples, a more uniform load distribution in the sling pad system 16 may be created when positioning the sealing region 76 shown in FIG. 17B compared to the sealing region 76 illustrated in FIG. 17A. Moreover, the sling pad system 16 may be free of a support 34, but may capture high pressure eject gases and, thus, may be more likely to create more normal load and, consequently, axial friction on the payload 12 during an eject event. As such, in instance in which this occurrence may be a concern for a particular launcher and payload 12, the inner sheet may define vent holes 80 and/or the example shown in FIG. 17B may be utilized in an uppermost launcher seal location where pressures may be lower as a launchers may contain five or more seals, in some examples.

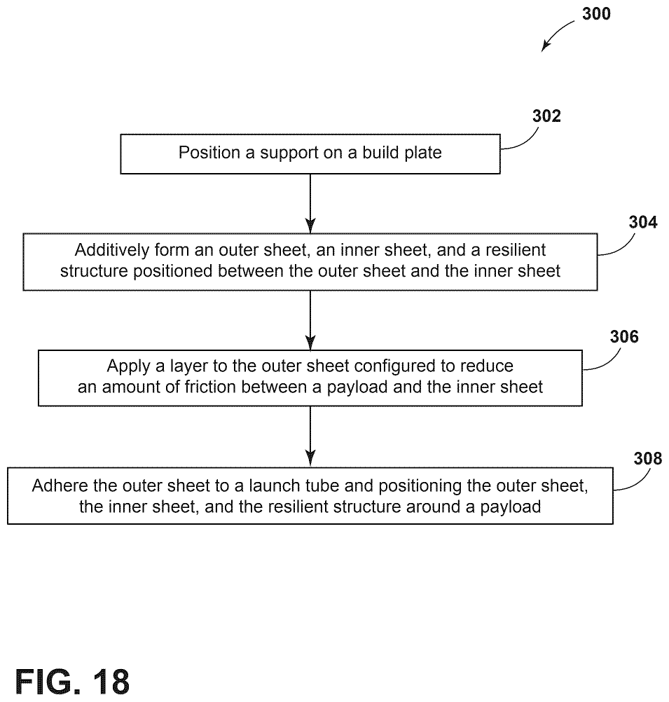

Referring now to FIG. 18, a flow diagram for manufacturing a payload assembly according to various examples of the present disclosure is illustrated. In general, the method 200 will be described herein with reference to the sling pad system illustrated in FIGS. 1-17B. However, it should be appreciated that the disclosed method 200 may be implemented with sling pad systems having any other suitable configurations. In addition, although FIG. 18 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

In some instances, manufacturing the payload assembly can include casting a sling pad system with the use of a casting machine. In examples in which the sling pad system is formed through casting, at (202), the method 200 may include placing an injector mold plate of a mold assembly in a defined position relative to an ejector mold plate to define a casting mold. At (204), the method 200 can include moving one or more corebars within the mold assembly along a common translational axis. In some instances, the one or more corebars within the mold assembly may translate axially and/or may be clones of a select number (e.g., 1-4) of profiles regardless of the sling pad diameter or an annular gap.

Moreover, at (206), the method 200 can include positioning a support within the mold assembly before injecting the material between the tool and the core. Additionally or alternatively, the support may be adhered to the inner sheet, and/or any other portion of the sling pad system after the forming of the outer sheet, the inner sheet, and/or the resilient structure. In some cases, the support can be configured as a preformed material formed from at least one of a metallic material, an elastomeric material, a polymeric material, or a synthetic material. Additionally or alternatively, the support can be configured as a thicker region along the inner sheet compared to the one or more structural elements.

At (208), the method can include injecting a material between the tool and the core to form an outer sheet, an inner sheet, and a resilient structure positioned between the outer sheet and the inner sheet.

At (210), the method 200 can include applying a layer to the inner sheet and/or the support. The layer may be configured to reduce an amount of friction between a payload and the inner sheet.

At (212), the method 200 can include adhering the outer sheet to a launch tube and positioning the outer sheet, the inner sheet, and the resilient structure around a payload. In some cases, various portions of the sling pad system may be notched or cut open in order to allow for various features attached to the payload to pass therealong and/or therethrough.

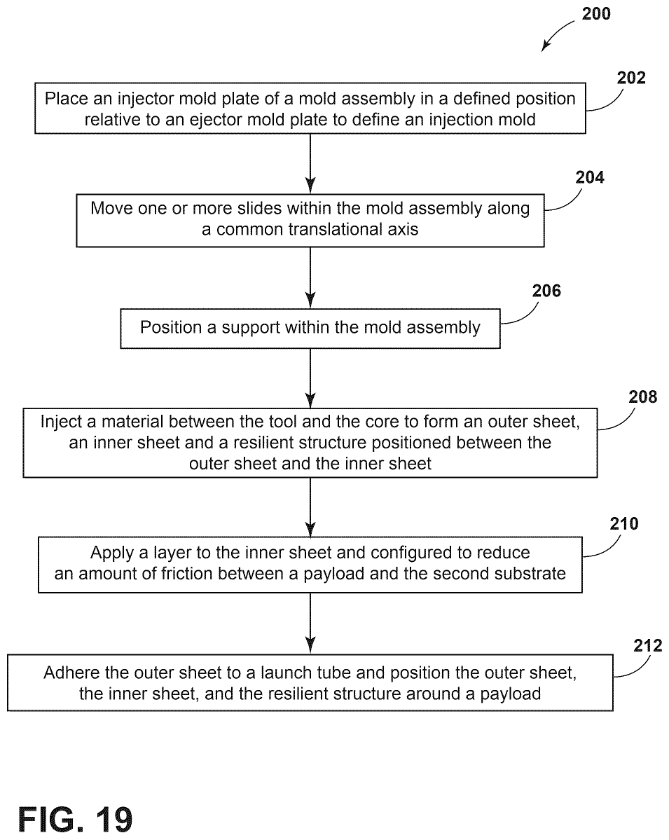

Referring now to FIG. 19, a flow diagram for assembling a payload assembly according to various examples of the present disclosure is illustrated. In general, the method 300 will be described herein with reference to the sling pad system illustrated in FIGS. 1-17B. However, it should be appreciated that the disclosed method 300 may be implemented with sling pad systems having any other suitable configurations. In addition, although FIG. 19 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

In some instances, manufacturing the payload assembly can include additively manufacturing the shock assembly system. Additive manufacturing is utilized to fabricate 3-dimensional (3D) parts or products by adding a layer-upon-layer of material. Additive manufacturing utilizes 3D modeling (Computer-Aided Design or CAD) software, computer-controlled additive-manufacturing equipment, and raw materials in solid (such as thermoplastics), powder, or liquid form. Additive manufacturing encompasses a wide variety of technologies and incorporates a wide variety of techniques, such as, for example, laser freeform manufacturing (LFM), laser deposition (LD), direct metal deposition (DMD), laser metal deposition, laser additive manufacturing, laser engineered net shaping (LENS), stereolithography (SLA), selective laser sintering (SLS), fused deposition modeling (FDM), multi-jet modeling (MJM), 3D printing, rapid prototyping, direct digital manufacturing, layered manufacturing, and additive fabrication.

In examples in which the sling pad system is formed through additive manufacturing, at (302), the method 200 can include positioning a support within the mold assembly before injecting the material between the tool and the core. Additionally or alternatively, the support may be adhered to the inner sheet, and/or any other portion of the sling pad system after the forming of the outer sheet, the inner sheet, and/or the resilient structure. In some cases, the support can be configured as a preformed material formed from at least one of a metallic material, an elastomeric material, a polymeric material, or a synthetic material. Additionally or alternatively, the support can be configured as a thicker region along the inner sheet compared to the one or more structural elements.

At (304), the method 300 can include additively forming an outer sheet, an inner sheet, and a resilient structure positioned between the outer sheet and the inner sheet. As provided above, the outer sheet, the inner sheet, and the resilient structure may be formed through any practicable additive manufacturing technology.

At (306), the method 300 can include applying a layer to the inner sheet and/or the support. The layer may be configured to reduce an amount of friction between a payload and the inner sheet.

At (308), the method 300 can include adhering the outer sheet to a launch tube and positioning the outer sheet, the inner sheet, and the resilient structure around a payload. In some cases, various portions of the sling pad system may be notched or cut open in order to allow for various features attached to the payload to pass therealong and/or therethrough.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A sling pad system to be disposed between a missile and a launch tube, the sling pad system comprising:
an outer sheet;
an inner sheet spaced from the outer sheet; and
a resilient structure positioned between the outer sheet and the inner sheet, the resilient structure comprising one or more structural elements operably coupled with the outer sheet at a first contact point and the inner sheet at a second contact point, wherein the one or more structural elements are tangent to the inner sheet at the second contact point.

2. The sling pad system of claim 1, wherein a first segment of the resilient structure is extended, and a second segment of the resilient structure is compressed when the missile is displaced from an initial axis.

3. The sling pad system of claim 2, wherein the first contact point is circumferentially offset from the second contact point about a common axis of the outer sheet and the inner sheet.

4. The sling pad system of claim 2, wherein the one or more structural elements include a first structural element and a second structural element, and wherein the first structural element intersects the second structural element at an intersection point between the first contact point and the second contact point.

5. The sling pad system of claim 2, further comprising:
a support operably coupled with the inner sheet.

6. The sling pad system of claim 5, wherein the support is configured as a thicker region along the inner sheet compared to the one or more structural elements.

7. The sling pad system of claim 6, wherein the support is configured as a preformed material formed from at least one of a metallic material, an elastomeric material, a polymeric material, or a synthetic material.

8. The sling pad system of claim 1, further comprising:
a sealing region configured to operably couple the outer sheet with the inner sheet.

9. The sling pad system of claim 8, wherein the sealing region is separated from the resilient structure between the inner sheet and the outer sheet.

10. The sling pad system of claim 1, further comprising:
a layer positioned on the inner sheet and configured to reduce an amount of friction between the missile and the inner sheet.

11. The sling pad system of claim 6, further comprising:
a layer positioned on the inner sheet and configured to reduce an amount of friction between the missile and the support.

12. A method of manufacturing a payload assembly, the method comprising:
placing an injector mold plate of a mold assembly in a defined position relative to an ejector mold plate to define a casting mold;
moving one or more corebars within the mold assembly along a common translational axis; and
injecting a material between the injector mold plate and the ejector mold plate to form an outer sheet, an inner sheet, and a resilient structure positioned between the outer sheet and the inner sheet, the resilient structure comprising a pair of structural elements each respectively coupled with the outer sheet and the inner sheet, the pair of structural elements intersecting at an intersection point between the outer sheet and the inner sheet, wherein the intersection point if offset from a radial midpoint between the outer sheet and the inner sheet.

13. The method of claim 12, further comprising:
applying a layer to the inner sheet and configured to reduce an amount of friction between a payload and the inner sheet.

14. The method of claim 13, further comprising:
positioning a support within the mold assembly before injecting the material between the injector mold plate and the ejector mold plate.

15. The method of claim 14, wherein the support is configured as a preformed material formed from at least one of a metallic material, an elastomeric material, a polymeric material, or a synthetic material.

16. The method of claim 12, further comprising:
adhering the outer sheet to a launch tube; and
positioning the outer sheet, the inner sheet, and the resilient structure around a payload.

17. A sling pad system to be disposed between a missile and a launch tube, the sling pad system comprising:
an outer sheet;
an inner sheet spaced from the outer sheet;
a resilient structure positioned between the outer sheet and the inner sheet, the resilient structure comprising a first structural element and a second structural element that intersect one another between the outer sheet and the inner sheet;
a support operably coupled with the inner sheet; and
a sealing region extending from the outer sheet to the inner sheet in a radial direction, the sealing region configured to extend axially inward or outward of an end portion of the outer sheet and the inner sheet in the radial direction.

18. (canceled)

19. The sling pad system of claim 17, wherein the sealing region is separated from the resilient structure between the inner sheet and the outer sheet.

20. The sling pad system of claim 17, wherein the sealing region is positioned between the inner sheet and the outer sheet and contacts an axial end portion of the resilient structure.

21. The sling pad system of claim 17, wherein the inner sheet defines a vent hole extending radially through the inner sheet.
